(19) United States
(12) Patent Application Publication
(10) Pub. No.: US 2008/0120446 A1
(43) Pub. Date: May 22, 2008

(54) THERMOSTAT WITH USB INTERFACE

(76) Inventors: William P. Butler, St. Louis, MS (US); Steven L. Carey, St. Louis, MO (US); Horst E. Jaeschke, Imperial, MO (US)

Correspondence Address: HARNESS, DICKEY, & PIERCE, P.L.C, 7700 BONHOMME, STE 400, ST. LOUIS, MO, 63105, US

(21) Appl. No.: 11/941,681

(22) Filed: Nov. 16, 2007

Related U.S. Application Data
(60) Provisional application No. 60/859,768, filed on Nov. 17, 2006.

(51) Int. Cl. G06F 13/12

(52) U.S. Cl. 710/63

(57) ABSTRACT

Various embodiments of a thermostat are provided that comprise at least one user input means for enabling the user to input at least one request, a universal serial bus interface, a display device capable of displaying at least a number of alphanumeric characters configured to display information relating to a service provider, and a microprocessor in communication with the universal serial bus interface, the display device and the user input means. The microprocessor is capable of monitoring the user input means for a request to retrieve information relating to a service provider, and is configured to respond to such a request by requesting communication through the universal serial bus interface of information relating to the service provider. The microprocessor (is further configured to communicate the information relating to the service provider to the display device, which information may include the name and phone number of the service provider.

### CROSS REFERENCE TO RELATED APPLICATIONS

This application claims the benefit of U.S. Provisional Patent Application Ser. No. 60/859,768, filed Nov. 17, 2006, the disclosure of which is incorporated herein by reference.

### FIELD

The present disclosure relates to thermostat controls for heating, ventilation and air conditioning systems, and more particularly to digital thermostats for such heating and cooling systems.

### BACKGROUND

The statements in this section merely provide background information related to the present disclosure and may not constitute prior art.

Heating and cooling systems typically operate under the control of a thermostat that an occupant or user may access for adjustment or control purposes. Many service providers that install new thermostats or service customer heating and cooling systems often place a sticker on the customer's thermostat that includes the service provider's name and contact information. In this manner, the customer may use this information at a later time when additional service may be required, and would not have to recall or remember the service provider's name. However, customers may find this unattractive and remove the sticker, thereby defeating the service provider's attempt to display their information for possible use in future customer service calls.

### SUMMARY

The present disclosure relates to a thermostat capable of retrieving information relating to a service provider from a source external to the thermostat, and displaying the information relating to a service provider. In the various disclosed embodiments, a thermostat is provided that comprises at least one user input means for enabling the user to input at least one request, a universal serial bus interface, a display device capable of displaying at least a number of alphanumeric characters configured to display information relating to a service provider, and a microprocessor in communication with the universal serial bus interface, the display device and the user input means. The microprocessor is capable of monitoring the user input means for a request to retrieve information relating to a service provider, wherein the microprocessor is configured to respond to such a user request by requesting communication through the universal serial bus interface of information relating to the service provider. The microprocessor is further configured to communicate the information relating to the service provider to the display device, which information may include the name and phone number of the service provider. In some preferred embodiments, the service provider information communicated to the microprocessor is continuously displayed by the display device upon restoration of the thermostat to normal operation, such that the information relating to the service provider is continuously viewable on the image screen displayed by the display device during normal operation of the thermostat.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a perspective view illustration of one embodiment of a thermostat according to the principles of the present application;

FIG. 2 is a functional illustration of a method of communicating information relating to a service provider to the thermostat embodiment shown in FIG. 1;

FIG. 3 is an illustration of a display device showing information relating to a service provider;

FIG. 4 is one embodiment of a thermostat display for use in various thermostat embodiments; and

FIG. 5 shows the thermostat display of FIG. 5 indicating a system fault, and a prompt to call for service;

FIG. 6 shows the thermostat display of FIG. 5 displaying the uploaded information of a service provider;

FIG. 7 shows the thermostat display of FIG. 5 indicating the detection of an attached USB memory device and options for upload and download of information;

FIG. 8 shows an example of a service providers text information that may be uploaded from a USB memory device to the thermostat;

FIG. 8 shows an example of operating parameters that may be uploaded or downloaded from a USB memory device to the thermostat;

FIG. 10 shows the thermostat display of FIG. 5 displaying options for download of specific information;

FIG. 11 shows the thermostat display of FIG. 5 displaying information of a history of sensor failures; and

FIG. 12 shows an example of operating parameters that may be downloaded from the thermostat to an attached USB memory device.

### DETAILED DESCRIPTION

The following description is merely exemplary in nature and is not intended to limit the present disclosure, application, or uses. It should be understood that throughout the drawings, corresponding reference numerals indicate like or corresponding parts and features.

According to various aspects of the present disclosure, there are provided various exemplary embodiments of a thermostat capable of retrieving information relating to a service provider from a source external to the thermostat, and displaying the information relating to a service provider. In the various embodiments, a thermostat is provided that comprises at least one user input means for enabling the user to input at least one request, a universal serial bus interface, a display device capable of displaying at least a number of alphanumeric characters configured to display information relating to a service provider, and a microprocessor in communication with the universal serial bus interface, the display device and the user input means. The microprocessor is capable of monitoring the user input means for a request to retrieve information relating to a service provider, wherein the microprocessor (or a program of the microprocessor) is configured to respond to such a user request by requesting communication through the universal serial bus interface of information relating to the service provider. The microprocessor (or a program of the microprocessor) is further configured to communicate the information relating to the service provider to the display device, which information may include the name and phone number of the service provider. In some preferred embodiments, the service provider information communicated to the microprocessor is continuously displayed by the display device upon restoration of the thermostat to normal operation, such that the information relating to the service provider is continuously viewable on the image screen displayed by the display device during normal operation of the thermostat. In another aspect, embodiments of a method for retrieving information relating to a service provider and displaying the information relating to a service provider on a thermostat are provided.

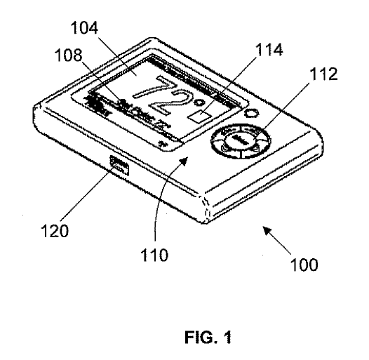

Referring to FIG. 1, one embodiment of a thermostat 100 according to the principles of the present application is shown, which includes a display device 104 and at least one user-input means 110. The display device 104 preferably includes a portion thereon that is configured to display a message thereon. In the first embodiment of a thermostat 100, the display device 104 includes a portion thereon that comprises at least a predetermined number of alphanumeric characters that permit the display of a message or information, such as the contact information of a service provider. It should be noted that the display device 104 may comprise a conventional liquid crystal display (LCD) configured to display various predetermined characters thereon, or alternatively a dot-matrix type LCD display device. The display device 104 may further comprise a touch-sensitive switch membrane 114 associated with an icon displayed on the display device 104, or a region on a touch-screen associated with an icon displayed on the display device 104. Accordingly, the display device 104 may be provided in various forms, and should not be limited to any particular form.

As shown in FIG. 1, the thermostat 100 preferably comprises a Universal Serial Bus (USB) interface 120 that is adapted to be connected to an external USB device, which device permits the communication of information to the thermostat. The USB interface is preferably an IEEE 1394 USB connector A Type (female receptacle) that adapted to receive or establish connection with a corresponding mating 1394 USB connector of a USB device. Alternatively, the USB interface may comprise a 1394 USB connector B Type (female receptacle), or any other equivalent connector that is adapted to receive or establish connection with a correspondingly similar 1394 USB connector of a USB device. Such a mating connector may be included on a USB cable, for example, that includes corresponding mating 1394 USB connector components for enabling connection to an external computer 150 or memory device. Accordingly, the USB interface may be connected to a USB cable device in connection with a portable computer or hand held palm-type device including information stored thereon. The USB interface is also adapted to be connected to a standalone USB device capable of communicating information stored in an electronic memory included thereon, such as a USB “flash” memory drive. The thermostat 100 further comprises a user input means 110 for enabling the input of at least a request for the retrieval of information relating to a service provider from an electronic memory in communication with the Universal Serial Bus interface.

The thermostat includes at least one user input means 110 for permitting the input of a selection of or request for retrieval of service provider information. The thermostat 100 preferably comprises one or more soft keys or buttons 112 similar to conventional thermostats, which provide for various user input functions such as adjusting temperature settings or operation modes. Conventional thermostats employing such soft keys are not well suited for manual input of information, given the limited number of soft keys. Entry of data utilizing such soft keys may be accomplished, for example, by using the soft keys to scroll through available characters on a displayed keyboard to select and enter one character at a time. Such manual selection and entry of individual characters, one at a time, can be cumbersome and time consuming for a busy service provider to utilize. Accordingly, in the first embodiment of a thermostat 100, at least one user input means 110 is provided for permitting the input of a request for the retrieval of service provider information. The service provider or installer of the thermostat 100 may, for example, simply press at least one soft key 112 (or one or more soft keys simultaneously) to prompt the thermostat's microprocessor to retrieve information via the USB interface. Alternatively, service provider or installer of the thermostat 100 may, for example, touch a region 114 on a touch membrane or a touch screen to prompt the thermostat's microprocessor to retrieve information. In this manner, the service provider would not have to go through the tedious process of repeatedly using a limited number of keys for scrolling through menu options to select installer settings, or for selecting from a list of available characters to enter their information.

It should be noted that the user input means 110 may comprise a conventional button-type input device 112, a touch-sensitive switch membrane 114 associated with an icon displayed on the display device 104, or a region on a touch-screen associated with an icon displayed on the display device 104. Accordingly, the at least one user input means for permitting the input of a request for retrieval of service provider information may be provided in various forms, and should not be limited to any particular form. In the first embodiment of a thermostat 100, at least one user input means is provided to permit the manual depression or selection of a button or icon, for inputting a request for the retrieval of information relating to a service provider from an electronic memory in communication with a Universal Serial Bus interface 120 of the thermostat 100.

The thermostat 100 preferably includes a processor for controlling the operation of the thermostat 100, which may be a microprocessor or the like. The microprocessor is in communication with the universal serial bus interface 120, the display device 104 and the user input means 110, and is capable of monitoring the user input means 110 for various inputs entered by a user or service provider, including an input of a selection or request to retrieve information relating to a service provider. The microprocessor is configured to respond to a specific input request to retrieve information relating to a service provider, by requesting the communication of information relating to a service provider from an electronic memory in communication with the universal serial bus interface 120.

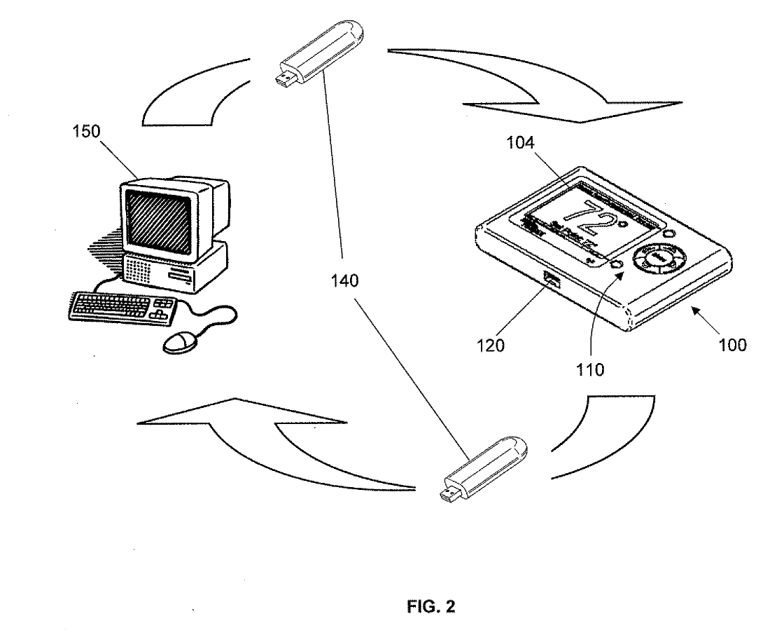

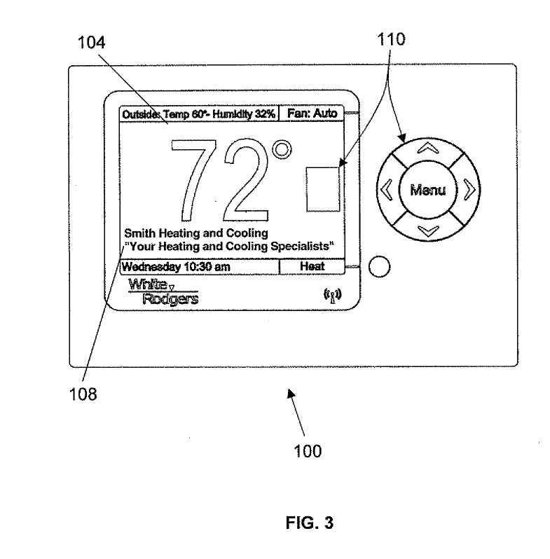

Referring to FIG. 2, the USB device that the USB interface 120 is adapted to connect to is preferably a portable USB memory device 140 that a service provider may carry, which includes information stored thereon relating to the service provider. The stored information may include at least a name and phone number of a service provider, and may preferably be included in an appropriately named data file that is recognizable by the microprocessor of the thermostat 100. For example, the microprocessor may be configured to look for or request a predetermined file name, in requesting the communication via the USB interface 120 of a data file contained in an external memory source (such as 140, for example). Alternatively, the microprocessor may be configured to identify and communicate to the display device 104 the name of at least one data file that is available for communication via the USB interface 120, so as to prompt a user to select at least one data file name being displayed on the display device 104, for communication to the microprocessor. Accordingly, the service provider may make an input via the input means 110 that is detected by the microprocessor, which responsively requests the communication via the USB interface 120 of a data file selected by the service provider, or a predetermined file name that is recognizable by the microprocessor of the thermostat. The data file is preferably an ASCI format or the like that may be configured or edited using a computer, for example, such that a service provider may edit and customize the information in the data file that the service provider would like to communicate to and display on the thermostat.

As previously stated, the microprocessor of the thermostat 100 may request the communication of information relating to a service provider via the USB interface 120 from an external memory source, such as the USB memory device 140. A service provider wishing to communicate its name and contact information to the thermostat for display would be able to do by connecting a USB memory device 140 to the USB interface 120 on the thermostat 100. Once the service provider has connected the USB memory device to the USB interface 120 of the thermostat 100, the service provider may utilize at least one user input means 110 to request the retrieval of information relating to the service provider. The service provider may manually depress a button, or select an icon, for example, to input a specific selection or request for the retrieval of information relating to a service provider from an electronic memory in communication with the Universal Serial Bus interface 120. Upon detecting the specific input via the user input means 110 of a request to retrieve information relating to a service provider, the microprocessor of the thermostat 100 would request the communication of information relating to a service provider from the USB memory device 140 in communication with the universal serial bus interface 120. The microprocessor may request the communication of an ASCI data file, for example, that was displayed to and selected by a service provider, or a data file that has a predetermined file name recognized by the microprocessor. The microprocessor is preferably configured to receive the information, or data file containing information relating to the service provider (such as name and contact information), and responsively communicate the information relating to the service provider to the display device 104. The service provider information communicated to the microprocessor is preferably communicated continuously to the display device 104 upon restoration of the thermostat to normal operation, such that the information relating to the service provider is continuously displayed or viewable on the image screen that is displayed by the display device 104 during normal operation of the thermostat. The thermostat 100 is configured to be restored to normal operation by the selection of at least one user input means 110, such that the information relating to the service provider is continuously displayed on the display device 104 when the thermostat is operating in its normal operation. Accordingly, the information relating to the service provider is advantageously provided or displayed continuously, rather than having to be instituted by selection of soft keys to access a menu through which the information may be obtained.

The microprocessor may further communicate the information relating to the service provider, or the data file containing the information, to an electronic memory (not shown) of the thermostat, such as a non-volatile Electronically Erasable Programmable Read-Only Memory (EEPROM) for example. The information relating to the service provider communicated via the USB interface 120 may be received by the microprocessor and also stored within the EEPROM memory, such that the information is not lost upon an interruption in power, or so that the microprocessor may retrieve the information whenever required for display. The microprocessor is preferably configured to request the communication via the USB interface 120 of a data file from an external memory source that contains information relating to the service provider, and to store the communication of information relating to the service provider in the memory, after which the microprocessor retrieves the stored information for communication to the display device 104. The microprocessor communicates the information to the display device 104 in a manner such that the information relating to the service provider is continuously displayed on the display device 104 when the thermostat is operating in its normal operation. The information relating to the service provider (such as a name and contact phone number) may be displayed in the portion of the display device 104 having a predetermined number of alphanumeric characters, such that the installed thermostat 100 may prominently display the name of the service provider on the display device 104 for an occupant of the space to see.

It should be noted that the information relating to the service provider is communicated by the microprocessor (or a program of the microprocessor) to the display device 104 in a manner such that the display device displays the service provider information in at least the normal or default screen of the thermostats display device 104. In this manner, the service provider's information or advertising message is immediately displayed prominently and continuously on the thermostat's normal display screen, upon completion of communicating the information via the USB interface and restoration of normal operation. Alternatively, the service provider may make a further input via the user input means 110 to configure the microprocessor (or a program of the microprocessor) to display the service provider's information only upon detection by the thermostat 100 of an operating condition or malfunction of the thermostat or HVAC system being controlled by the thermostat.

In the first embodiment of a thermostat, the display device 104 may display information relating to the service provider, which may at least include the service provider's name and phone number. The information relating to the service provider could alternatively include other contact information, such as a website or email address, or the name of an employee or manager of the service provider. Similarly, the service provider information may include a phrase or expression used by the service provider in their advertising. Accordingly, the information relating to the service provider is not limited to only contact information. It should be noted that the information or advertising relating to the service provider may vary in length and content, and the thermostat 100 is configured to display information that may include more than the predetermined number of alphanumeric characters on the display device 104, as explained below.

In some embodiments of a thermostat, such as the first embodiment 100 above, the display device 104 may further be configured to display a message or information that comprises more characters than the predetermined number of characters that may be displayed on the display device. The thermostat 100 is preferably configured to receive a message of significant length from a furnace control, which message includes diagnostic information that the thermostat's microprocessor and display device 104 would be configured to display in a scrolling marquee format. For example, the thermostat may receive diagnostic information from a furnace control, which may indicate a failed attempt to attain ignition due to either a faulty hot surface igniter or a degraded flame sensor. The thermostat could accordingly display this failure information in a scrolling marquee fashion on a portion 108 of the display device 104. The thermostat may be configured by the service provider via the user input means to display the service provider's information only in the event of a detected operating condition or malfunction such as that above, and the service provider's name and contact information could be displayed in a scrolling marquee format following the diagnostic information. In this manner, the thermostat would enable the service provider to avail their services at a future time when service is required.

Moreover, the various embodiments of a thermostat according to the principles of the present disclosure may be capable of communicating stored information to a service provider. For example, a separate gas appliance control may transmit diagnostic information indicating a failed attempt to verify ignition due to a degraded flame sensor, which information is communicated to the thermostat. The various thermostat embodiments could accordingly save this information and display this information in a scrolling marquee fashion on a portion of the display device. In some embodiments of a thermostat including a Universal Serial Bus interface, the thermostat would also be capable of communicating messages or information that it has obtained (and stored in memory) relating to diagnostic or operating conditions of various components of a heating or cooling system. The thermostat's display device is capable of displaying at least a predetermined number of alphanumeric characters to permit display of operational information to a viewer of the thermostat, such as the failed ignition attempt, for example. The displayed operational information may also include instructions that a viewer of a thermostat would be able to follow, for inputting a request to communicate stored information to a USB flash memory device, for example, that a service provider has connected to the USB interface. Thus, the present thermostat would also enable the communication of stored historical operating information via the USB interface to a USB device or component of a service provider, which information could assist the service provider in trouble-shooting a heating or cooling system.

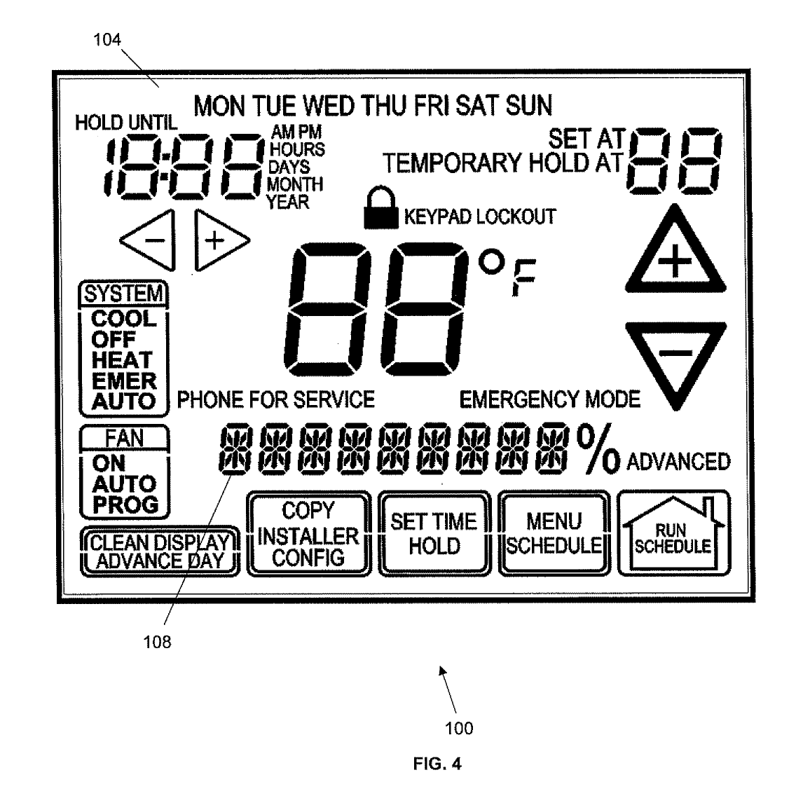

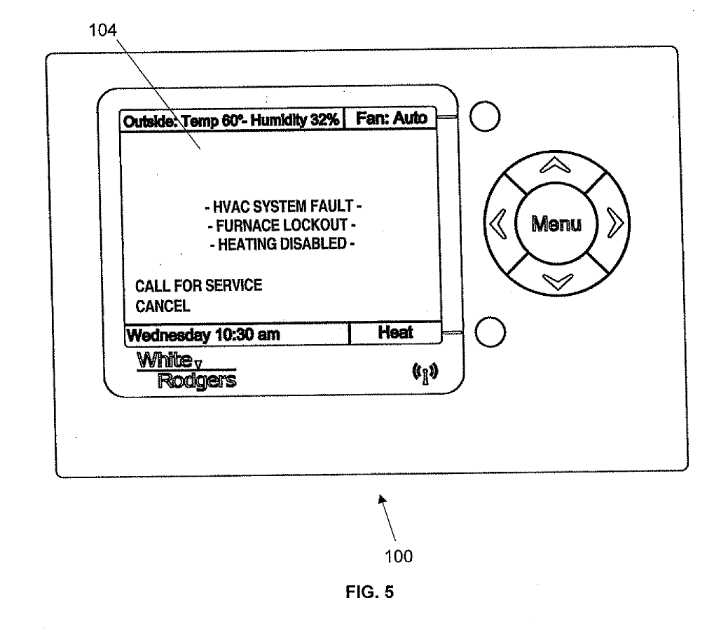

In some embodiments of a thermostat, such as the first embodiment 100 above, the display device 104 includes a portion 108 thereon that is capable of displaying a plurality of segments capable of forming characters. The microprocessor and display device 104 are configured to initially display a first segment of characters of an ASCII text message (relating to diagnostic information or the service provider) within the predetermined number of characters on a portion of the display device. After displaying the first segment of characters for a predetermined time period, the thermostat's microprocessor and display device 104 are configured to scroll the remaining text information to allow for displaying the entire ASCII text message in a scrolling marquee manner. This display device 104 may be, for example, a Liquid Crystal Display that comprises a predetermined number of characters having a plurality of segments that may be used to display alphanumeric symbols to form words, numbers or other characters. For example, the Liquid Crystal Display (LCD) may be configured to display 20 characters that each comprise 14 segments for a total of 280 icons, which LCD would be much less costly than a dot matrix LCD display, which may have as many as 6,000 icons. Such an LCD display provides an advantage over dot matrix type thermostats, in that it consumes less power, is less expensive, and would not need a driver that is required with a dot matrix display. An example of such a thermostat LCD display is shown in FIG. 4, and is disclosed in U.S. patent application Ser. No. 11/156,391, filed Jun. 20, 2005, entitled “Thermostat Capable of Displaying Received Information”, which disclosure is incorporated by reference in its entirety. However, where added display capability is desired, the display device 104 may alternatively comprise a dot matrix display that the microprocessor could communicate to (in conjunction with a driver), for providing a continuously updated display of information in a scrolling marquee display format.

Various embodiments of a thermostat according to the principles of the present disclosure may be capable of displaying a scrolling marquee to provide a simple means for displaying service provider information of varying lengths, without using up a substantial portion of the display area. Such thermostat embodiments may accordingly display information relating to a service provider received via a USB interface 120, and may display the information without having to truncate or parse the information. The thermostat would simply be able to receive information and responsively display the information as received in its entirety on the display device 104 to the user, such that the service provider would be able to advertise or provide contact information for availing their services at a future time when service is required. The service provider information may further be displayed in connection with the display of required routine maintenance, such as the display of “filter replacement”, for example. The service provider's name and phone number could be displayed following the maintenance information, so that the customer could call for service. No matter what the size or length of the message or information the service provider wishes to display on the thermostat, the microprocessor of the thermostat 100 and display device 104 may be configured to display the service provider's information or advertising message.

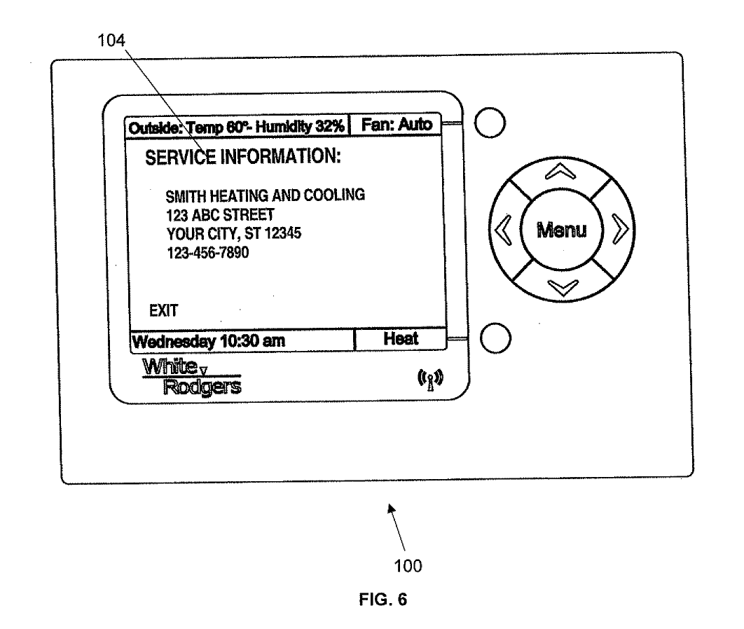

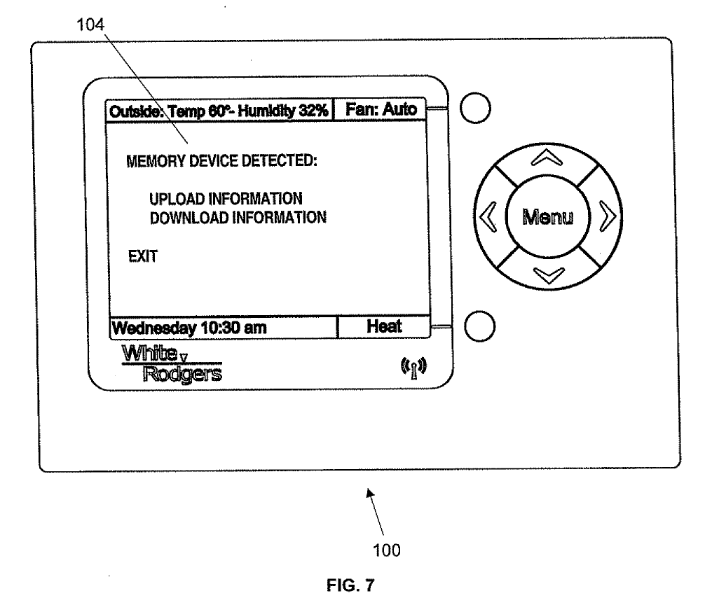

In the various embodiments, a thermostat is provided that includes a Universal Serial Bus interface 120 and user input means 110 that permit a service provider to connect an external USB device to the thermostat and input a request to prompt the communication of information relating to the service provider to the thermostat via the USB interface 120, which information may be prominently presented on the thermostat's display device 104. The cost associated with the inclusion of a USB interface 120 in the thermostat is easily recovered through the opportunity of availing the service provider's contact information for repeat service calls in the future. The service provider may install such novel and advantageous thermostats for numerous customers, and may carry a portable USB memory device to conveniently and quickly communicate information relating to the service provider from the USB memory device to each of the installed thermostats via their USB interface 120. Such thermostats having a USB interface 120 for communicating service provider information also provide the customer with the benefit of an easily accessible contact for a service provider, in the event that future service is required by the customer. Upon the occurrence of an HVAC system fault such as a furnace lockout that disables the furnace, the thermostat 100 is configured to display the system fault on a display device 104 of the thermostat as shown in FIG. 6. The thermostat 100 may retrieve the stored service provider information that was uploaded from a USB device, and display the information on the display device 104 as shown in FIG. 7. Accordingly, the disclosed embodiment of a thermostat 100 configured to display service provider information communicated via a USB interface addresses a long felt, unmet need for enabling the simple and convenient input of service provider information, and provides the valuable benefit of displaying service provider information that may be readily used by the customer when future service is required.

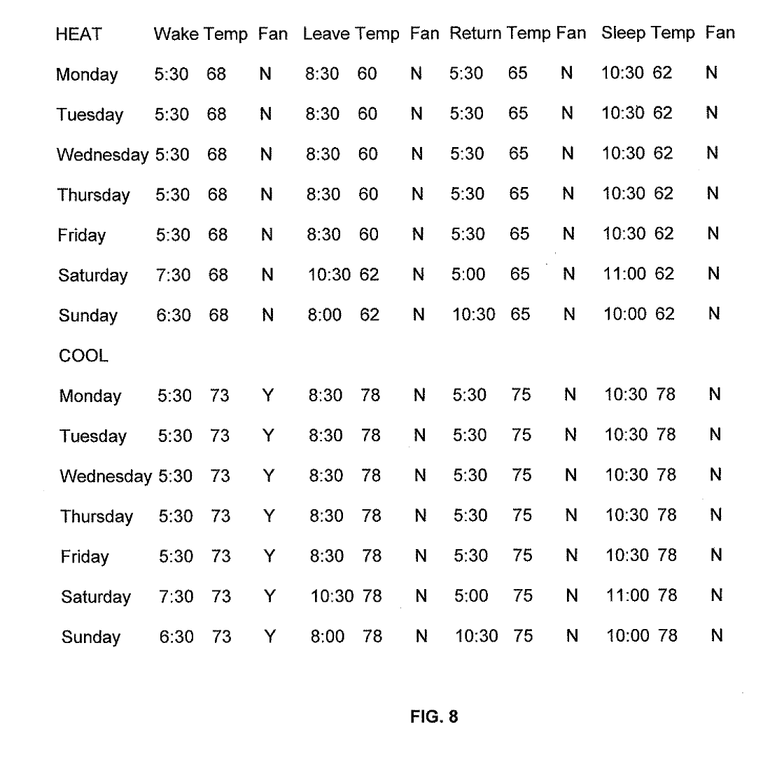

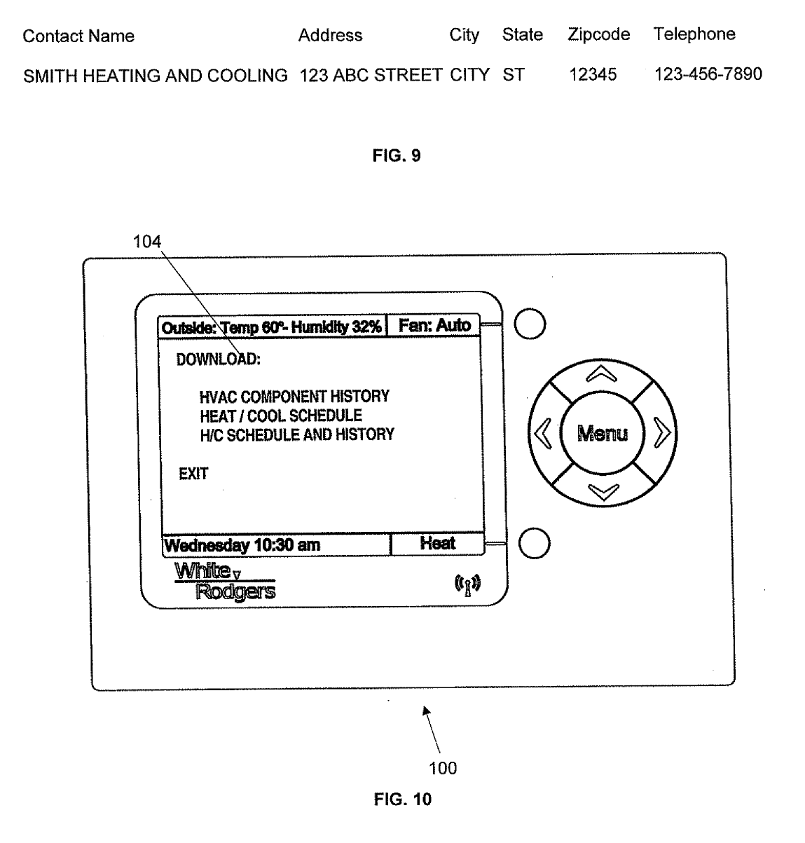

In view of the above disclosure, it should be noted that the above thermostat embodiment may also be configured to download information pertaining to the thermostat or HVAC system to a USB memory device connected to the USB interface. As shown in FIG. 8, the thermostat 100 is configured to display on a display device 104 the detection of a memory device that is connected to the USB interface 120. Upon connection of a USB memory device to the thermostat's USB interface 120, the thermostat displays on a display device 104 the text “USB detected”, as well as the option to upload or download information. For example, the thermostat may be configured to upload to the thermostat 100 time and temperature values in a file settings.txt (or .dat) as shown in FIG. 9, or the contractor's address and phone number in the file contractor.txt (or .dat) as shown in FIG. 10. These files are ASCII files that would most likely have a .dat file subscript.

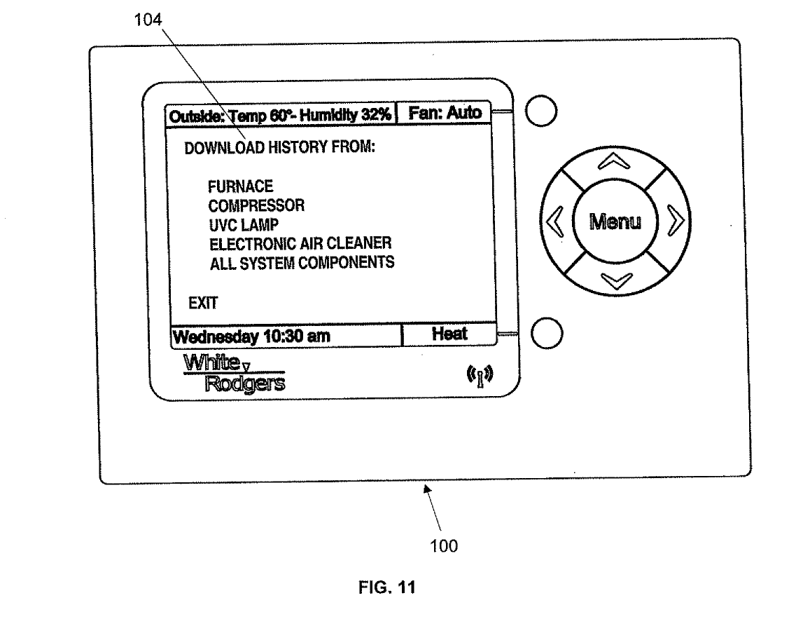

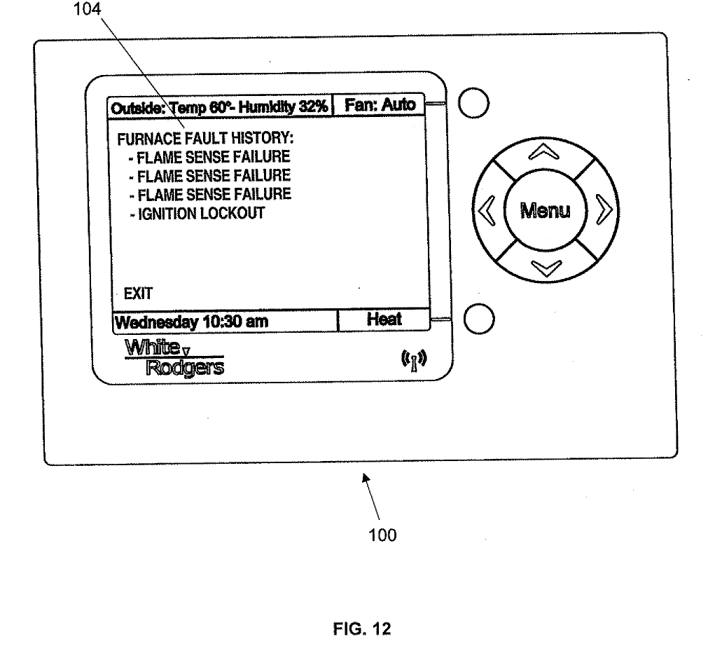

When a USB memory device is connected to the thermostat's USB interface, the thermostat is further capable of retrieving operating parameter data, such as the temperature set point and time periods for programming heat and cool scheduled periods. Additionally, the thermostat 100 could download the fault history of a particular component or all HVAC components to a USB memory device, as indicated in FIGS. 11 through 13. Such information could be stored on a USB memory device connected to the thermostat's USB interface, and accessed by a service repairman for troubleshooting HVAC operating problems.

In an alternate embodiment, a thermostat 200 is provided that includes a USB interface, and requires a USB memory device to provide operating parameters that are required for thermostat operation. In this embodiment, the USB memory device is preferably an integral part of the thermostat in that it is necessary for the thermostat's operation. The USB connector 104 and USB memory device connected thereto may be enclosed or covered by a door on the thermostat's housing, such that the USB memory device is not readily visible. The USB memory device preferably has operational factory default parameters loaded onto it at the time of manufacture. If the user wishes to change the default parameter settings, the user may utilize buttons or other input means on the thermostat for changing the temperature set points stored on the USB memory device for example. However, it may be easier to remove the USB device from the thermostat and use a computer, desktop, laptop, or other device to change the default values, rather than to use the user interface on the thermostat to edit the parameters. Once the USB is removed from the thermostat, the thermostat control will cease to operate, because the operational parameters or code stored on the USB are missing. The USB memory device preferably stores operating parameters such as temperature set points for various time periods that are required for the thermostat to operate.

In this alternate embodiment, the USB memory device may also have a resident program stored on it, or an executable program to launch a program on a separate PC that the USB memory device, either program of which could allow a user to connect the USB to a computer to view and edit the stored parameters on the USB. For example, the program could be a resident program, or an operating system such as the U3 smart OS found on the “cruzer” from Sandisk, which launches a program resident on the USB memory device allowing the user to program the operating parameters (such as temperature set points and various time periods). Alternatively, the data of the various ACII .dat files using a text editor such as “Notepad”, found on the various Microsoft operating systems. Alternatively the USB may have an “autorun” file located on it, such that an operating system is not required to boot the resident software, similar to inserting a CD in a CD drive and having a program boot. The program would be a simple user interface written Microsoft Visual Basic, for example.

Upon completion of any editing of parameters such as temperature set points or time periods, or service provider information, the program implemented via the remote computer would store the data file on the USB, which would then be re-connected to the thermostat. The thermostat 100 preferably includes a microprocessor (not shown) for controlling the thermostat that would then operate using the new parameters. Similarly, a service provider may remove the USB memory device, and edit a service provider data file on a remote computer, to enter the service provider's name and address, for example. Upon completion, the service provider may save the file, and re-connect the USB to the thermostat. The thermostat 100 (or the thermostats microprocessor) is preferably configured to detect a malfunction of the heating or cooling system, and to responsively store a message indicative of the malfunction on a memory of the removable universal serial bus device. Upon detecting a malfunction, the microprocessor is configured to retrieve from the removable universal serial bus device the stored contact information relating to the service provider that includes at least a phone number of the service provider. The thermostat would then prompt the display device to display the contact information of the service provider on the display device of the thermostat. This is especially advantageous, because the service provider (contacted by the occupant viewing the contact information) may easily remove the universal serial bus device and connect it to a remote computer, laptop or other handheld computing device to retrieve any stored messages indicative of a malfunction of the heating or cooling system from the universal serial bus device. For example, the thermostat could detect a signal from a furnace indicating the malfunction of a furnace inducer motor and its corresponding horsepower or part number, and responsively store the message on the universal serial bus device. The service provider would be able to promptly obtain the part number of the motor requiring replacement to more quickly restore the heating system to operation.

Additionally, the feature of uploading to the thermostat time and temperature setting information could also allow for upgrades to be made, or other changes to the operational capability of the thermostat. For example, in the above embodiment of a thermostat 200 with a USB interface 204 that requires a USB memory device, the thermostat is configured to sense the temperature surrounding the thermostat. However, the home owner may wish to utilize a remote temperature sensor in another location of the home in which the thermostat is not able to sense a temperature increase or decrease. Accordingly, the owner may purchase a wireless remote temperature sensor and upgrade to a USB device that includes both a memory and a wireless transceiver that is able to receive signals transmitted from the wireless remote temperature sensor. The wireless remote temperature sensor may be configured to transmit via wireless RF signals, or via Bluetooth technology, for example. The transmitter in the temperature sensor may be a programmable transmitter chip, such as, for example, a Chipcon Chip #CC1070 manufactured and sold by Chipcon. The transceiver chip in the USB memory device for receiving transmitted information may be, for example, a Chipcon #CC1020 sold and manufactured by Chipcon. It should be noted that the transmitter of the remote sensors and the transceiver of the USB device may utilize any other suitable means of receiving transmissions. Such a wireless remote temperature sensor may be a F0148-1328 remote sensor manufactured and sold by the White-Rodgers Division of Emerson Electric Co, and is disclosed in U.S. patent application Ser. No. 10/990,897, which is incorporated herein by reference. Accordingly, the owner may remove the original USB memory device from the USB interface, and connect an upgrade USB memory and transceiver device to the USB interface, upon which the thermostat would detect the connection of the USB device having a wireless transceiver. The upgraded thermostat would then be able to receive signals from the wireless remote temperature sensor indicating the temperature of the location in which the owner installed the remote sensor. Accordingly, the owner would also be able to remove the new upgraded USB device, and connect it to a remote computer to edit the temperature set points in the file to stored on the USB memory device, to take advantage of the new remote sensor.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A thermostat comprising:
a universal serial bus interface adapted to connect to a universal serial bus device;
a display device having at least a portion thereof that is capable of displaying a message;
at least one input means for enabling the input of at least one request; and
a microprocessor in communication with the universal serial bus interface, the display device and the user input means, the microprocessor being configured to respond to a specific input request by requesting communication of information relating to a service provider from an electronic memory in communication with the universal serial bus interface, and subsequently communicating the information relating to a service provider to the display device, wherein the information relating to a service provider includes at least a name and phone number of the service provider.

2. The thermostat of claim 1 wherein the information relating to a service provider includes at least a name and phone number of the service provider.

3. The thermostat of claim 1 wherein the thermostat is configured to be restored to normal operation by the selection of at least one user input means, and the information relating to the service provider is continuously displayed on the display device when the thermostat is operating in its normal operation.

4. The thermostat of claim 3 wherein the microprocessor requests the communication via the USB interface of a data file that contains information relating to the service provider.

5. The thermostat of claim 4 wherein the data file has a predetermined file name that is recognizable by the microprocessor of the thermostat.

6. The thermostat of claim 4 wherein the microprocessor displays one or more data files that are available for communication via the USB interface on the display device, and prompts the user to select a specific data file to communicate to the microprocessor.

7. The thermostat of claim 4 further comprising an electronic memory for storing the information relating to the service provider.

8. The thermostat of claim 7 where the microprocessor causes the communicated information relating to the service provider to be stored in the memory, and the microprocessor subsequently retrieves the stored information for communication to the display device.

9. A thermostat comprising:
a universal serial bus interface adapted to connect to a universal serial bus device;
at least one user input means for enabling the user to input at least one request;
a display device capable of displaying a plurality of alphanumeric characters for displaying alphanumeric information;
a microprocessor in communication with the universal serial bus interface, the display device and the user input means, the microprocessor being capable of monitoring the user input means for a request to retrieve information relating to a service provider, and being configured to respond to such a user request by requesting communication of information through the universal serial bus interface of information relating to the service provider, and communicating the information relating to the service provider to the display device, wherein the information relating to the service provider includes at least a name and phone number of the service provider.

10. The thermostat of claim 9 the thermostat is configured to be restored to normal operation by the selection of at least one user input means, and the information relating to the service provider is continuously displayed on the display device when the thermostat is operating in its normal operation.

11. The thermostat of claim 9 wherein the microprocessor displays at least one data file that is available for communication via the USB interface on the display device, and prompts the user to select at least one data file to communicate to the microprocessor.

12. The thermostat of claim 11 wherein the microprocessor requests the communication via the USB interface of a data file that contains information relating to the service provider.

13. The thermostat of claim 9, further comprising an electronic memory for storing the information relating to the service provider, wherein the microprocessor is configured to request the communication via the USB interface of a data file from an external memory source that contains information relating to the service provider and to store the communication of information relating to the service provider in the memory, subsequent to which the microprocessor retrieves the stored information for communication to the display device.

14. The thermostat of claim 13 wherein the microprocessor communicates the information relating to the service provider to the display device in a manner such that the information relating to the service provider is continuously displayed on the display device during normal operation of the thermostat.

15. A thermostat comprising:
a universal serial bus interface adapted to connect to a universal serial bus device having at least an electronic memory thereon;
a removable universal serial bus device including a memory having a plurality of stored time and temperature setting values that are required for the thermostat to operate, which removable universal serial bus device is connected to the universal serial bus interface such that the thermostat may access the stored time and temperature setting values;
at least one user input means for enabling the user to input at least one request;
a display device capable of displaying at least a predetermined number of alphanumeric characters configured to display alphanumeric information; and
a microprocessor in communication with the universal serial bus interface, the display device and the user input means, the microprocessor being capable of retrieving parameters, including time and temperature settings, that are stored on the universal serial bus for controlling the operation of a heating or cooling system, whereupon removal of the universal serial bus device the thermostat discontinues operation.

16. The thermostat of claim 15, wherein the microprocessor is further configured to detect a malfunction of the heating or cooling system and to responsively store a message indicative of the malfunction on a memory of the removable universal serial bus device.

17. The thermostat of claim 16, wherein microprocessor is further configured to detect a malfunction of the heating or cooling system, and in response to detecting a malfunction, the microprocessor is configured to retrieve from the memory on the removable universal serial bus device the stored contact information relating to the service provider that includes at least a phone number of the service provider, and to prompt the display device to display the contact information of the service provider on the display device of the thermostat.

18. The thermostat of claim 16 wherein the microprocessor retrieves at least one a data file stored on the universal serial bus device that contains contact information relating to the service provider in the event of a malfunction of the thermostat, and controls the display device to display the contact information relating to the service provider.

19. The thermostat of claim 18 wherein the universal serial bus device further includes a wireless transceiver that is configured to receive signals from a wireless remote temperature sensor, the universal serial bus device being configured to communicate sensed temperature information received from the wireless remote temperature sensor to the microprocessor.

20. A thermostat comprising:
a memory device for storing information obtained by the thermostat relating to the operation of the thermostat or at least one component of a heating or cooling system;
a universal serial bus interface adapted to connect to a universal serial bus flash memory device;
a display device having a portion thereon capable of displaying at least a predetermined number of alphanumeric characters to permit display of operational information to a viewer of the thermostat;
at least one user input means for enabling the user to input a request to the thermostat to initiate communication via the universal serial bus interface of stored information relating to the operation of the thermostat or at least one component of a heating or cooling system;
a microprocessor in communication with the electronic memory, the universal serial bus interface, the display device and the user input means, the microprocessor being capable of monitoring the user input means for a request to retrieve and communicate information stored in the memory relating to the operation of the thermostat or at least one component of a heating or cooling system, wherein the microprocessor is configured to respond to such a request by retrieving information stored in the memory relating to the operation of the thermostat or at least one component of a heating or cooling system, and requesting communication of the stored information through the universal serial bus interface in a manner such that the information may be stored in a universal serial bus flash memory device connected to the universal serial bus interface.
